(19) United States
(12) Patent Application Publication
(10) Pub. No.: US 2025/0240574 A1
(43) Pub. Date: Jul. 24, 2025

(54) DIAPHRAGM AND SPEAKER UNIT

(71) Applicant: ONKYO CORPORATION, Osaka (JP)

(72) Inventor: Takeshi FUJITANI, Osaka (JP)

(73) Assignee: ONKYO CORPORATION, Osaka (JP)

(21) Appl. No.: 18/951,751

(22) Filed: Nov. 19, 2024

(30) Foreign Application Priority Data
Jan. 24, 2024 (JP) 2024-008967

(51) Int. Cl. H04R 7/14; H04R 7/12; H04R 9/02; H04R 9/04; H04R 9/06

(52) U.S. Cl. CPC H04R 7/14; H04R 7/122; H04R 9/025; H04R 9/045; H04R 9/06; H04R 2400/11

(57) ABSTRACT

A diaphragm in which one axis direction length and the other axis direction length are different in two orthogonal axis directions seen from a top and which has a predetermined shape that both sides in a longitudinal direction which is the one axis direction are constituted of curved lines, the diaphragm comprising: a first reinforcing part which extends along the longitudinal direction; and a second reinforcing part which is provided adjacent to the first reinforcing part in a short direction and which is a mesh shape raised-recessed portion.

### CROSS-REFERENCE TO RELATED APPLICATIONS

This application claims priority to Japanese Application No. 2024-008967, filed Jan. 24, 2024, the entire contents of which are incorporated herein by reference.

### FIELD

The present disclosure relates to a diaphragm and a speaker unit including the diaphragm.

### BACKGROUND

As shapes of diaphragms that are used for speaker units, there are a general perfect circular shape and irregular shapes that can support a TV and a laptop PC of which mounting spaces are limited. As the irregular shapes, there are an oval shape and a track shape (see FIG. 28). In the diaphragm of the irregular shape, an aspect ratio of a longitudinal direction and a short direction is large and improvement of its characteristics is attained by providing a reinforcing rib along the longitudinal direction to make rigidity of an entire diaphragm uniform (see FIG. 29). Each of the above mentioned shapes of the diaphragms is a shape seen from the top. However, with respect to the linear reinforcing ribs, increasing the rigidity of a portion around the rib by the linear reinforcing rib is difficult. If the width of the rib is broadened, a weight balance against the short direction collapses and a large peak dip occurs depending on characteristics.

To solve the above mentioned problem, JP 2021-125869 A describes a diaphragm in which a raised rib of broad width is provided (see FIG. 30). However, in a long and narrow shape diaphragm in which aspect ratio is large, weight balance against a short direction collapses, a rolling gap is easy to be caused, and further a peak dip occurs depending on characteristics. Further, JP 2021-125869 A describes a diaphragm that a dragonfly wing veins pattern is provided on a raised rib (see FIG. 31). However, the weight of a longitudinal direction further increases and an effect of the raised rib becomes small by the wing veins pattern.

As described above, in the prior art, there is a problem that peak dips occur.

### SUMMARY OF THE DISCLOSURE

According to one aspect of the disclosure, there is provided a diaphragm in which one axis direction length and the other axis direction length are different in two orthogonal axis directions seen from a top and which has a predetermined shape that both sides in a longitudinal direction which is the one axis direction are constituted of curved lines, the diaphragm comprising: a first reinforcing part which extends along the longitudinal direction; and a second reinforcing part which is provided adjacent to the first reinforcing part in a short direction and which is a mesh shape raised-recessed portion.

### BRIEF DESCRIPTION OF THE DRAWINGS

FIG. 1 is a perspective diagram illustrating a diaphragm according to an embodiment of the present disclosure.

FIG. 2 is a top diagram illustrating the diaphragm according to the embodiment of the present disclosure.

FIG. 3 is a perspective diagram illustrating the diaphragm and the like according to the embodiment of the present disclosure.

FIG. 4 is a perspective diagram illustrating a speaker unit according to the embodiment of the present disclosure.

FIG. 5 is a model diagram illustrating a comparative example 1.

FIG. 6 is a model diagram illustrating a comparative example 2.

FIG. 7 is a model diagram illustrating a comparative example 3.

FIG. 8 is a model diagram illustrating an embodiment example.

FIG. 9 is a graph illustrating frequency characteristics of the embodiment example and the comparative example 1.

FIG. 10(a) is a diagram illustrating movement of a model of the embodiment example in 2300 Hz.

FIG. 10(b) is a diagram illustrating movement of a model of the comparative example 1 in 2300 Hz.

FIG. 11(a) is a diagram illustrating movement of a model of the embodiment example in 3200 Hz.

FIG. 11(b) is a diagram illustrating movement of a model of the comparative example 1 in 3200 Hz.

FIG. 12(a) is a diagram illustrating movement of a model of the embodiment example in 9200 Hz. FIG. 12(b) is a diagram illustrating movement of a model of the comparative example 1 in 9200 Hz.

FIG. 13 is a graph illustrating frequency characteristics of the embodiment example, the comparative example 2 and the comparative example 3.

FIG. 14(a) is a diagram illustrating movement of a model of the embodiment example in 2500 Hz. FIG. 14(b) is a diagram illustrating movement of a model of the comparative example 2 in 2500 Hz.

FIG. 15(a) is a diagram illustrating movement of a model of the embodiment example in 3700 Hz.

FIG. 16(a) is a diagram illustrating a wavefront of a longitudinal direction of the embodiment example in 2300 Hz.

FIG. 16(b) is a diagram illustrating a wavefront of a longitudinal direction of the comparative example 1 in 2300 Hz.

FIG. 17(a) is a diagram illustrating a sound pressure distribution of a longitudinal direction of the embodiment example in 2300 Hz.

FIG. 17(b) is a diagram illustrating a sound pressure distribution of a longitudinal direction of the comparative example 1 in 2300 Hz.

FIG. 18(a) is a diagram illustrating a wavefront of a longitudinal direction of the embodiment example in 3200 Hz.

FIG. 18(b) is a diagram illustrating a wavefront of a longitudinal direction of the comparative example 1 in 3200 Hz.

FIG. 19(a) is a diagram illustrating a sound pressure distribution of a longitudinal direction of the embodiment example in 3200 Hz.

FIG. 19(b) is a diagram illustrating sound pressure distribution of a longitudinal direction of the comparative example 1 in 3200 Hz.

FIG. 20(a) is a diagram illustrating a wavefront of a longitudinal direction of the embodiment example in 9200 Hz.

FIG. 20(b) is a diagram illustrating a wavefront of a longitudinal direction of the comparative example 1 in 9200 Hz.

FIG. 21(a) is a diagram illustrating a sound pressure distribution of a longitudinal direction of the embodiment example in 9200 Hz.

FIG. 21(b) is a diagram illustrating a sound pressure distribution of a longitudinal direction of the comparative example 1 in 9200 Hz.

FIG. 22(a) is a diagram illustrating a wavefront of the embodiment of a longitudinal direction of the embodiment example in 20000 Hz.

FIG. 22(b) is a diagram illustrating a wavefront of a longitudinal direction of the comparative example 1 in 20000 Hz.

FIG. 23(a) is a diagram illustrating a sound pressure distribution of a longitudinal direction of the comparative example 1 in 20000 Hz.

FIG. 23(b) is a diagram illustrating a sound pressure distribution of a longitudinal direction of the comparative example 1 in 20000 Hz.

FIG. 24(a) is a diagram illustrating a wavefront of a longitudinal direction of the embodiment example in 2500 Hz.

FIG. 24(b) is a diagram illustrating a wavefront of a longitudinal direction of the comparative example 2 in 2500 Hz.

FIG. 25(a) is a diagram illustrating a sound distribution of a longitudinal direction of the embodiment example in 2500 Hz.

FIG. 25(b) is a diagram illustrating a sound distribution of a longitudinal direction of the comparative example 2 in 2500 Hz.

FIG. 26(a) is a diagram illustrating a wavefront of a longitudinal direction of the embodiment example in 3700 Hz.

FIG. 26(b) is a diagram illustrating a wavefront of a longitudinal direction of the comparative example 2 in 3700 Hz.

FIG. 27(a) is a diagram illustrating a sound distribution of a longitudinal direction of the embodiment example in 3700 Hz.

FIG. 27(b) is a diagram illustrating a sound distribution of a longitudinal direction of the comparative example 2 in 3700 Hz.

FIG. 28 is a perspective diagram illustrating a conventional diaphragm.

FIG. 29 is a perspective 1 diagram illustrating a conventional diagram.

FIG. 30 is a perspective diagram illustrating a diaphragm described in JP 2021-125869 A.

FIG. 31 is a perspective diagram illustrating a perspective diagram of a diaphragm described in JP 2021-125869 A.

### DETAILED DESCRIPTION OF THE PREFERRED EMBODIMENTS

An objective of the present disclosure is to suppress occurring of a peak dip in a diaphragm.

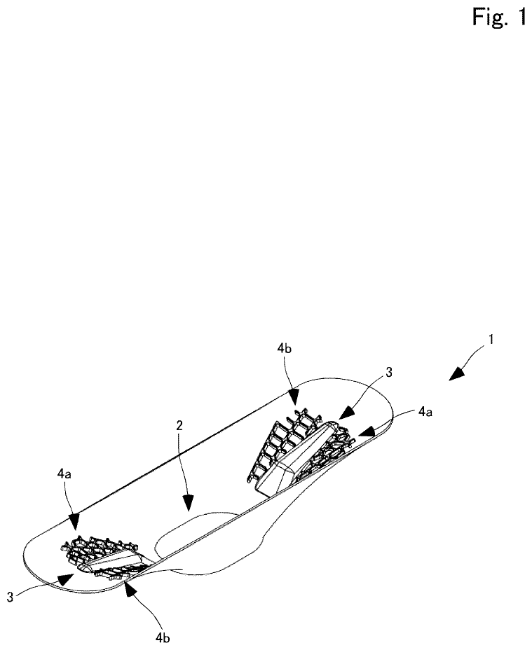

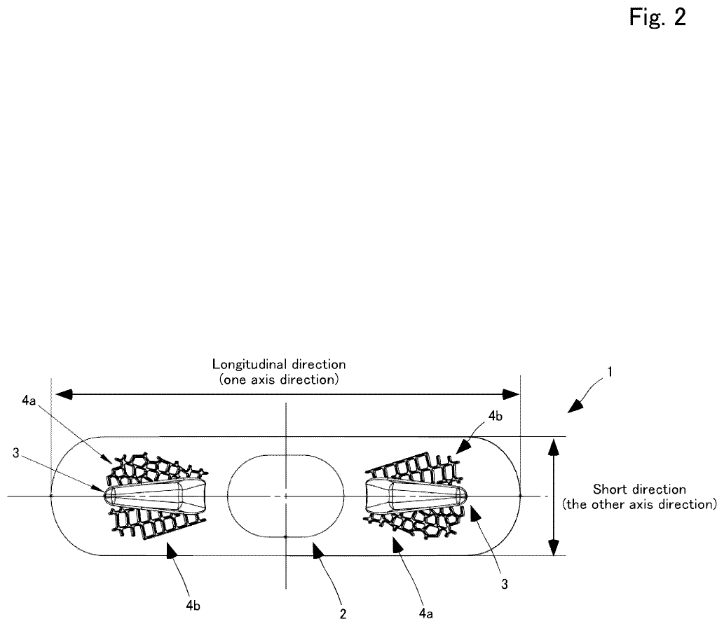

An embodiment of the present disclosure is described. Numeral values explained below are examples and not limited to these numeral values. FIG. 1 is a perspective diagram of a diaphragm 1 according to the embodiment of the present disclosure. FIG. 2 is a top diagram of the diaphragm 1 according to the embodiment of the present disclosure. In the embodiment, only a cone paper body is defined as the diaphragm 1.

The diaphragm 1 includes an opening 2, a first reinforcing part 3, a second reinforcing part 4 and the like. As illustrated, length of one axis direction of the diaphragm 1 and length of the other axis direction of the diaphragm 1 are different in two orthogonal axis directions seen from the top and a shape of the diaphragm 1 is a predetermined shape that each of both sides of the longitudinal direction that is one axis direction is constituted of a curved line. Concretely, the shape of the diaphragm 1 is a track shape (a predetermined shape) seen from the top. Herein, the “track shape” is a shape that is constituted of two equal length parallel lines and two semicircles and so-called a shape that is used in an athletics stadium. The shape of the diaphragm 1 may be an oval shape (a predetermined shape) seen from the top. Herein, the “oval shape” includes an almost oval shape that is close to the oval shape. The “track shape” includes an almost track shape that is close to the track shape.

The length of the longitudinal direction (one axis direction) of the diaphragm 1 is 59.6 mm, for example. Further, the length of the short direction (the other axis direction) of the diaphragm 1 is 15.1 mm, for example. Therefore, an aspect ratio of the longitudinal direction and the short direction of the diaphragm 1 is approximately 4:1. The length of the longitudinal direction and the length of the short direction of the diaphragm are not limited to the above examples. As described above, the length of the longitudinal direction of the diaphragm 1 and the length of the short direction of the diaphragm 1 are different each other. An aspect ratio a:b of the longitudinal direction and the short direction is a>1 in case of b=1. The aspect ratio of the longitudinal direction and the short direction of the diaphragm 1 is described below.

The diaphragm 1 has the opening 2 in its center. A shape of the opening 2 is a track shape. The shape of the opening 2 is not limited to the track shape and may be an oval shape, for example. The diaphragm 1 is formed by a raised shape curved surface from the opening 2 (a center) to a circumference.

The first reinforcing part 3 that extends along the longitudinal direction is provided in the diaphragm 1. The first reinforcing part 3 is a so-called rib. Two reinforcing parts 3 are provided across the opening 2 in the longitudinal direction. Two reinforcing parts 3 are provided at symmetrical positions (symmetrical positions in case where the short direction is used as a symmetrical axis) across the opening 2. Two reinforcing parts 3 may be provided at non-symmetrical positions (non-symmetrical positions in case where the short direction is used as a symmetrical axis) across the opening 2.

Width of the reinforcing part 3 gets thinner gradually from a center along the longitudinal direction (toward outside of the longitudinal direction). Namely, a shape of the first reinforcing part 1 is almost a triangle shape seen from the top. The width of the reinforcing part 3 may be constant and extend almost linearly along the longitudinal direction seen from the top. Further, it is sufficient that the first reinforcing part 3 has a portion which extends along the longitudinal direction. For example, in an end part which is opposite to the opening 2, an almost U shape rib which sandwiches the portion which extends along the longitudinal direction may be provided.

Further, in the diaphragm 1, the second reinforcing parts 4 (4a, 4b) are provided adjacently to the first reinforcing part 3 in the short direction. The reinforcing part 4 is a mesh shape raised-recessed portion. The second reinforcing part 4 spreads radially from the center along the longitudinal direction (from the opening 2 toward outside of the longitudinal direction). Two second reinforcing parts 4 are provided across the first reinforcing part 3 in the short direction. The two second reinforcing parts 4a and 4b across the first reinforcing part 3 have mesh shapes different from each other. Two sets of two second reinforcing parts 4a and 4b are provided across the opening 2 (a center of the longitudinal direction). The two second reinforcing parts 4a are point-symmetrical against the center of the diaphragm 1. Similarly, the two second reinforcing parts 4b are point-symmetrical against the center of the diaphragm 1. The second reinforcing part 4 does not overlap the first reinforcing part 3. Namely, the first reinforcing part 3 and the second reinforcing part 4 are arranged independently from each other.

For example, the width of a raised portion in the second reinforcing part 4 is 0.3 mm. For example, the height of the raised portion is 0.5 mm. The width and the height are not limited to these numerical values.

The second reinforcing part 4 imitates a wing of an insect. The recessed-raised portion of the wing of the insect can be imitated based on data obtained by measurement of the shape of a wing vein of an actual insect. For example, the position of intersections between the wing veins is two-dimensionally specified from a photograph of the insect and is converted into data. These intersections are connected to each other so that the recessed-raised portion imitating actual wing veins can be reproduced. In the actual wing veins, distances between the wing vein intersections vary. The wing veins form such a recessed-raised portion that many polygons (mainly a triangle, a rectangle, or a pentagon) having various sizes and shapes are connected to each other. The recessed-raised portion of the wing veins achieves a structure having strength and lightness necessary as the wing for the insect to fly.

Note that the dimensions of the recessed-raised portion utilized for the diaphragm are not limited to those coincident with actual insect wing vein dimensions, and it is practical that these dimensions are enlarged several times upon utilization. Since an actual insect wing area is small, it is suitable to enlarge, upon utilization, the dimensions with the relative ratio of the size of the recessed-raised portion being held. Further, the recessed-raised portion formed by the veins of the wing of the insect may be utilized such that vein portions are thick raised portions and film portions surrounded by the wing veins are thin recessed portions, and a thick dimension is not necessarily accurately imitated.

The recessed-raised portion is formed such that multiple identical wing vein shapes having a predetermined area are repeatedly arranged. For example, the recessed-raised portion is formed based on the data obtained by measurement of the shape of the wing veins of the actual dragonfly. The recessed-raised portion is not limited to the dragonfly and may imitate wings of other insects such as a cicada, a butterfly, a beetle, and a lady beetle.

Further, based on consideration that the recessed-raised portion of the wing of the insect has similarity to a Voronoi diagram, the recessed-raised portion imitating the wing veins of the insect can be produced from data of a produced Voronoi diagram. The Voronoi diagram is a diagram obtained in such a manner that some points (mother points) are taken on a plane and are connected by lines to draw a figure, perpendicular bisectors of sides of formed triangles are connected to draw a figure, and the initially-produced lines are eliminated. The Voronoi diagram can be also taken as a diagram obtained in such a manner that mother points arranged on a plane are divided according to the proximity to other mother points. Thus, the perpendicular bisectors connected in the Voronoi diagram are used so that the recessed-raised portion imitating the wing veins of the insect can be drawn. The recessed-raised portion may be formed based on data of a Voronoi diagram imitating the wing veins of the insect.

In the wing veins forming the recessed-raised portion of the wing of the insect, body fluid flows only upon stretching out of the wing. After the wing has been formed, the wing veins in which the body fluid has flowed become dry and empty. This contributes to the structure having both of strength and lightness necessary for the wing. Thus, in the diaphragm 1 having the recessed-raised portion imitating the wing of the insect according to the present disclosure, a hollow space imitating the wing veins of the insect may be formed inside.

For example, in the recessed-raised portion imitating the wing of the insect, the density of a diaphragm material in the thick raised portion may be lower than the density of a diaphragm material of the thin recessed portion. Further, in a diaphragm formed by bonding of a front material and a back material, the diaphragm may be formed such that thin recessed portions are bonded to each other and a hollow space in which the front material and the back material are not bonded to each other is provided inside the thick raised portions.

The “insect wing” is so-called insect wings, is thinly-extended external skeleton of a back, and is made of chitin. The “wing vein” means thick chitin strings which expand across the insect wing as in leaf veins for supporting the wing expanded in a film shape.

Note that the reinforcing part 4 may not imitate the insect wing. For example, the second reinforcing part 4 has a plurality of polygonal shape raised portions and a plurality of polygonal shape recessed portions which are formed in insides of the raised portions by the raised portions. In the plurality of raised portions, one side of the adjacent raised portion may be a part which forms both polygons. Other shapes of the second reinforcing part 4 are described below.

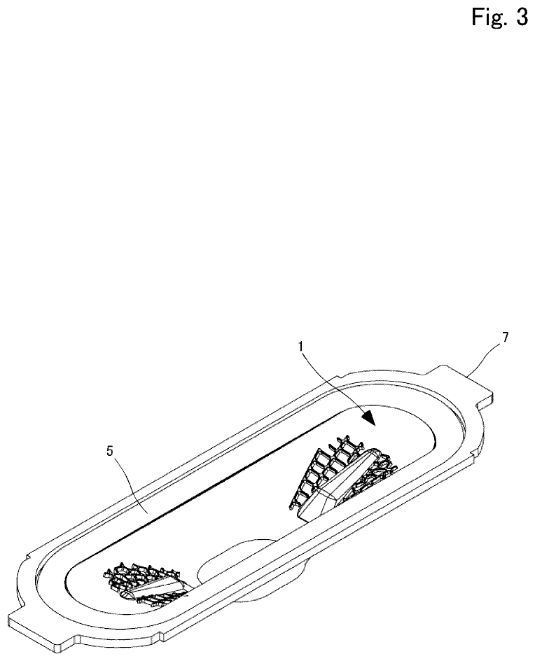

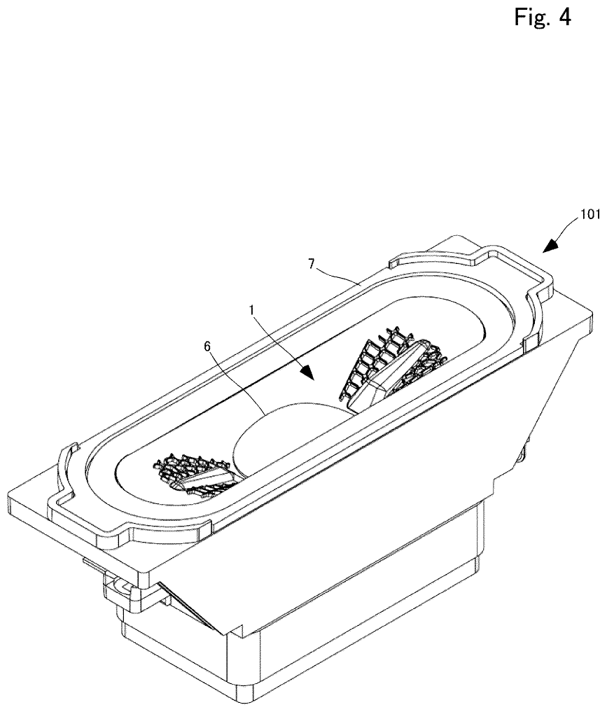

FIG. 3 is a perspective diagram illustrating the diaphragm 1 according to the embodiment. FIG. 4 is a perspective diagram illustrating a speaker unit 101 according to the embodiment. The speaker unit 101 includes the diaphragm 1, a voice coil, a dust cap 6, an edge 5, a frame 7, a magnetic circuit and the like. The voice coil is coupled to the opening 2 of the diaphragm 1. The voice coil has a bobbin and a coil which is wound to the bobbin. The dust cap 6 is connected to the voice coil. Concretely, the dust cap 6 is attached to a tip of the bobbin by an adhesive, for example. The edge 5 is coupled to an outer peripheral portion of the diaphragm and supports the diaphragm 1 so as to be vibrated. For example, the material of the edge 5 is NBR hardness 60.

The frame 7 is coupled to an outer peripheral portion of the edge 5. The magnetic circuit is fixed to the frame 7. The magnetic circuit has a magnetic gap in which the coil of the voice coil is arranged. The magnetic circuit is constituted of a top plate, a pole and a magnet. The top plate is annular and fixed to the frame 7. The pole is cylindrical and has a center pole which is inserted into a circular opening which is formed at a center of the top plate, and a flat under plate. The magnet is annular.

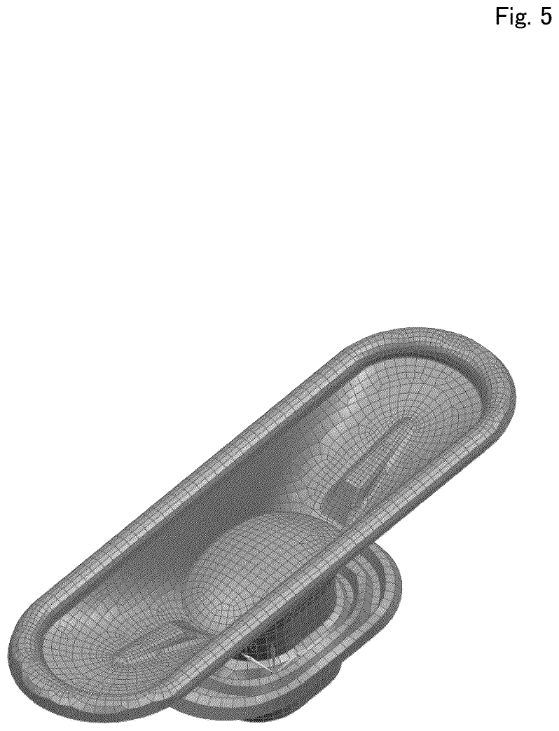

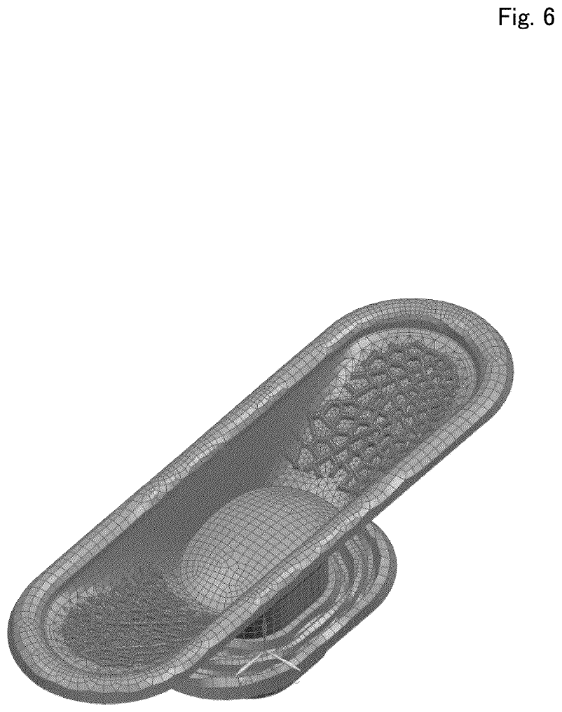

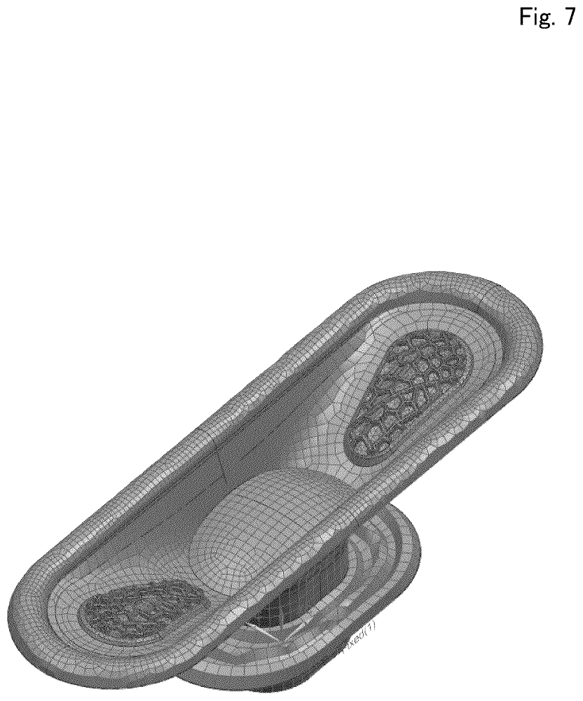

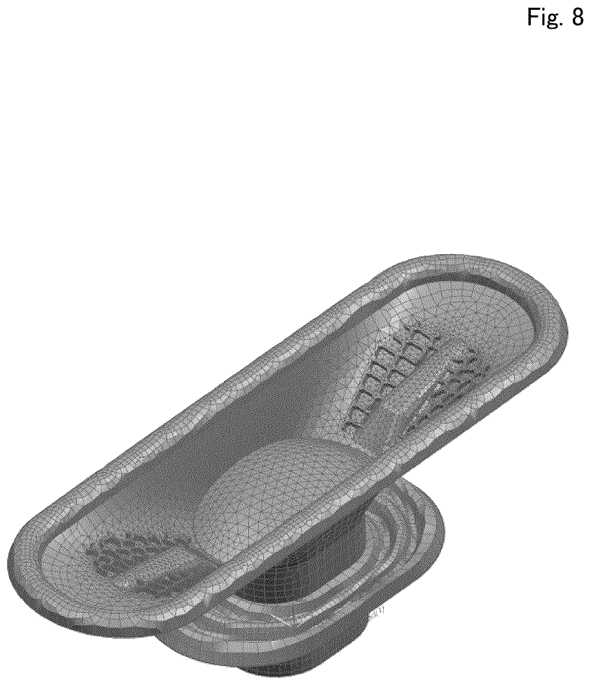

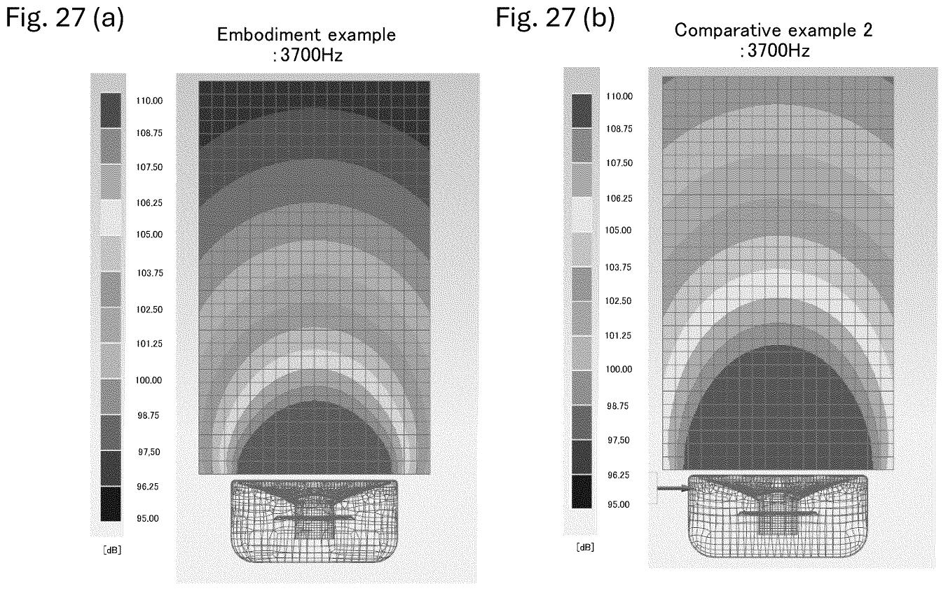

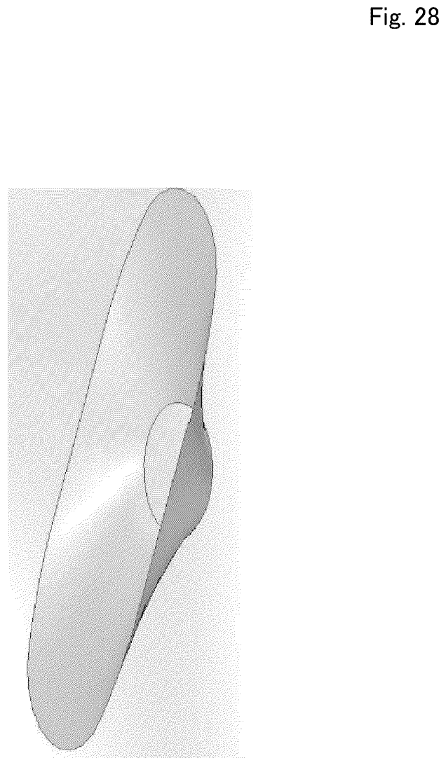

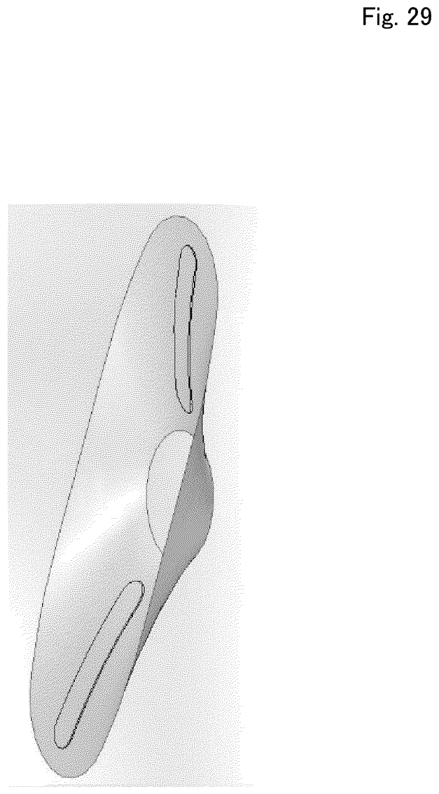

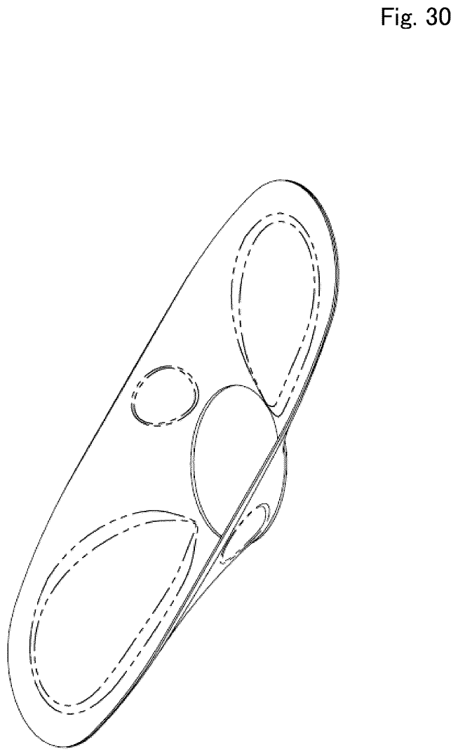

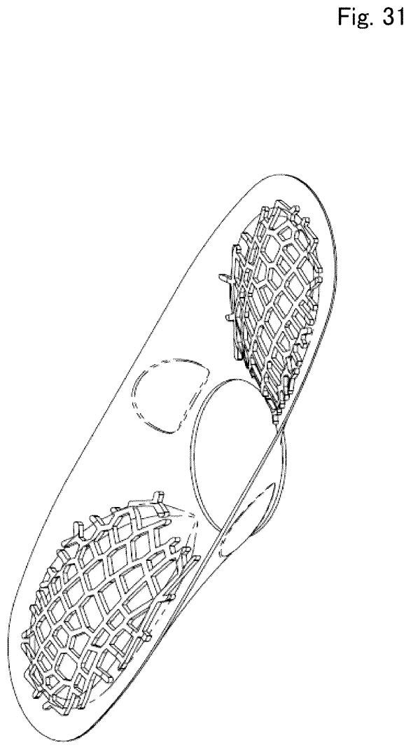

Characteristics of the diaphragm 1 according to the embodiment are described compared with the other examples below. FIG. 5 is a model diagram illustrating a diaphragm that the first reinforcing part 3 (a linear shape reinforcing rib) of the diaphragm 1 is only provided and the second reinforcing part 4 of the diaphragm 1 is not provided (comparative example 1). FIG. 6 is a model diagram illustrating a diaphragm that the first reinforcing part 3 of the diaphragm 1 is not provided and the second reinforcing part 4 (a recessed-raised shape wing veins pattern rib) over broad range of the diaphragm 1 is provided (comparative example 2). FIG. 7 is a model diagram illustrating a diaphragm that a recessed-raised shape of the second reinforcing part 4 of the diaphragm 1 (a recessed-raised shape wing veins pattern rib) is provided on a raised shape reinforcing part (a raised rib) similarly to a diaphragm illustrated in FIGS. 27-32 of JP 2021-125869 A (comparative example 3). FIG. 8 is a model diagram illustrating the diaphragm 1 according to the embodiment (embodiment example). Each model is made by arranging a predetermined shape voice coil and damper to each of diaphragms illustrated in FIGS. 5-8. Each result of acoustic analysis by boundary element method (BEM) is described below. In the comparative examples 1-3 and the embodiment example, calculation is performed under the same analysis conditions (driving force: 1 N, microphone distance: 1 m).

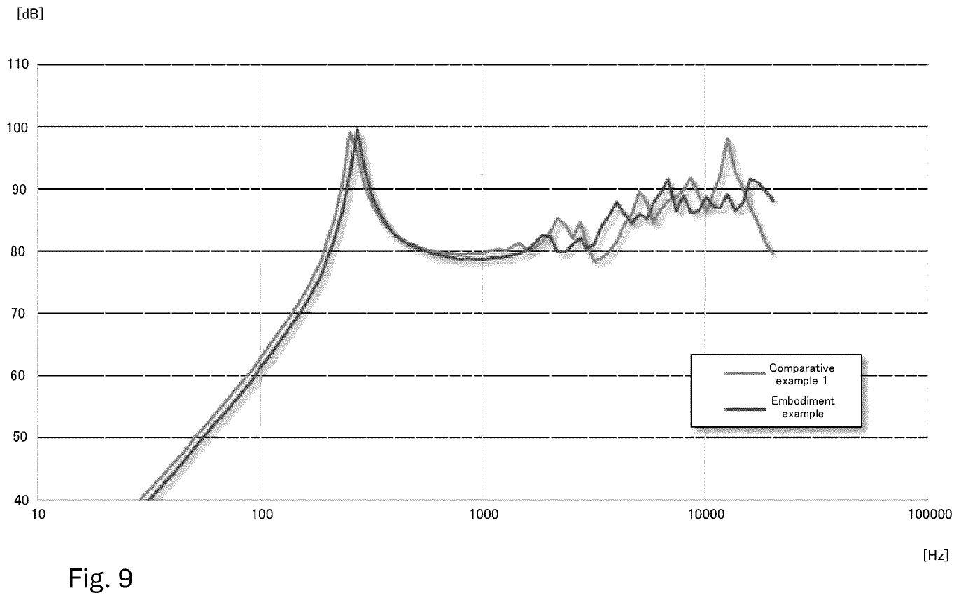

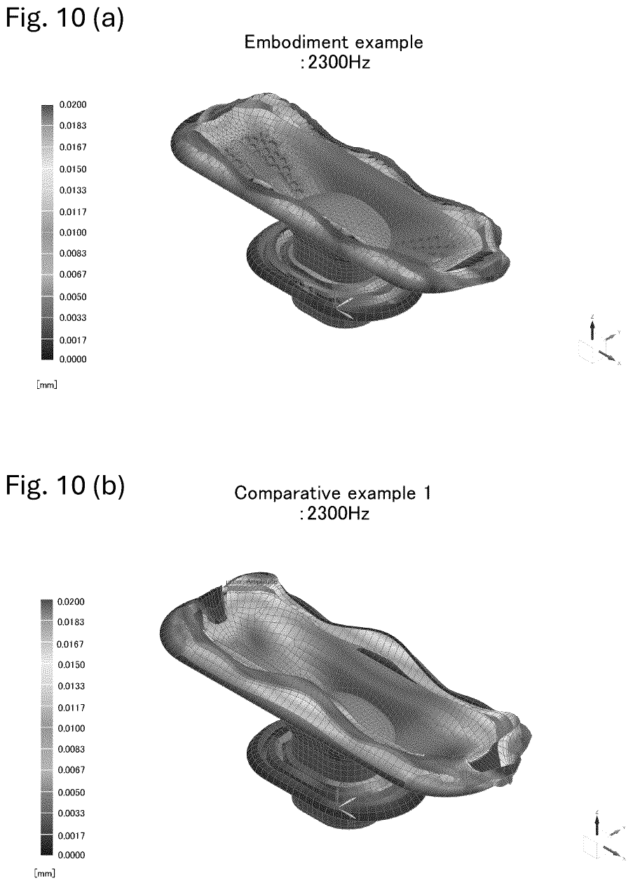

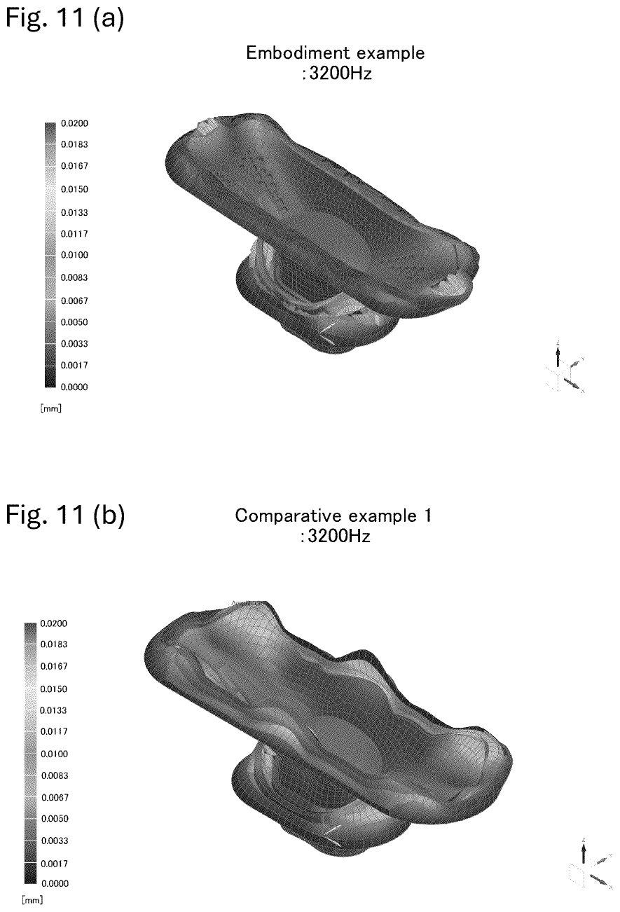

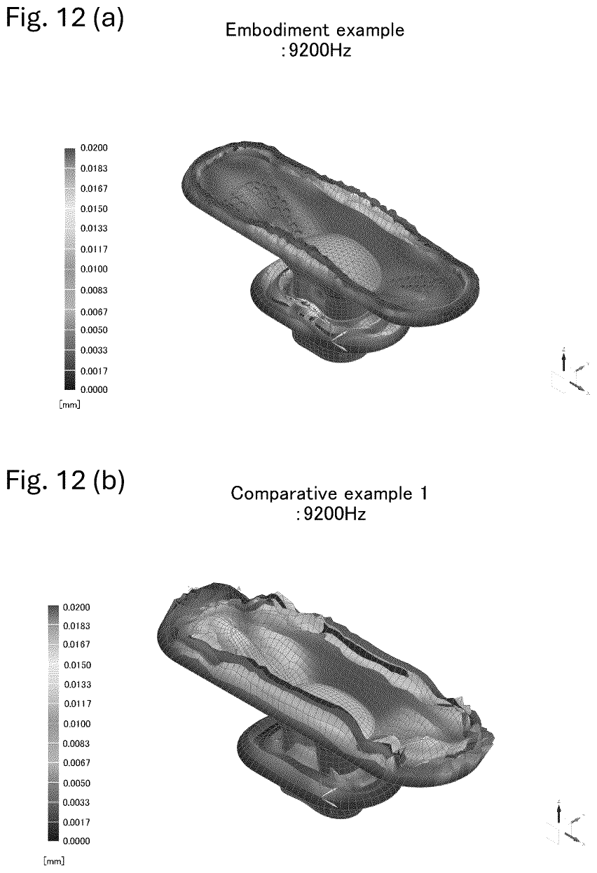

FIG. 9 is a graph illustrating frequency characteristics of the embodiment example and the comparative example 1. FIG. 10(a) is a diagram illustrating movement of a model of the embodiment example in 2300 Hz. FIG. 10(b) is a diagram illustrating movement of a model of the comparative example 1 in 2300 Hz. In the comparative example 1, flapping of an edge is large and there are peak dips due to the rigidity shortage around a linear shape reinforcing rib. Meanwhile, in the embodiment example, there is no flapping of an edge and peak dips are suppressed since the second reinforcing part (a recessed-raised wing veins pattern rib) is arranged around the first reinforcing part (a linear shape reinforcing rib). FIG. 11(a) is a diagram illustrating movement of a model of the embodiment example in 3200 Hz. FIG. 11(b) is a diagram illustrating movement of a model of the comparative example 1 in 3200 Hz. In the comparative example 1, an opposite phase mode in a longitudinal direction is seen and large dips occur. Meanwhile, in the embodiment example, such dips do not occur. FIG. 12(a) is a diagram illustrating movement of a model of the embodiment example in 9200 Hz. FIG. 12(b) is a diagram illustrating movement of a model of the comparative example 1 in 9200 Hz. In the comparative example, flapping in a longitudinal direction is seen. Meanwhile, the entire rigidity increases, resonance peaks are efficiently dispersed by the second reinforcing part (a recessed-raised wing veins pattern rib) and a few peak dips occur.

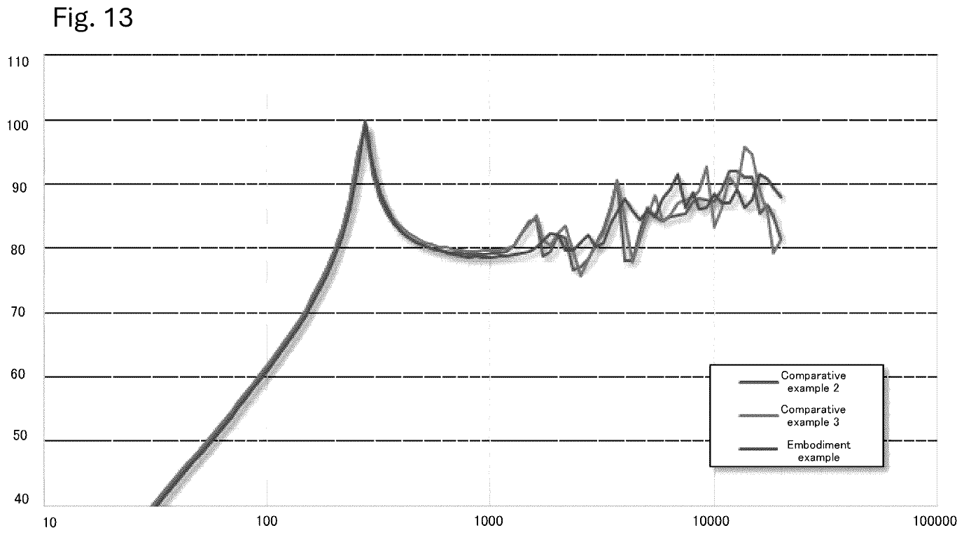

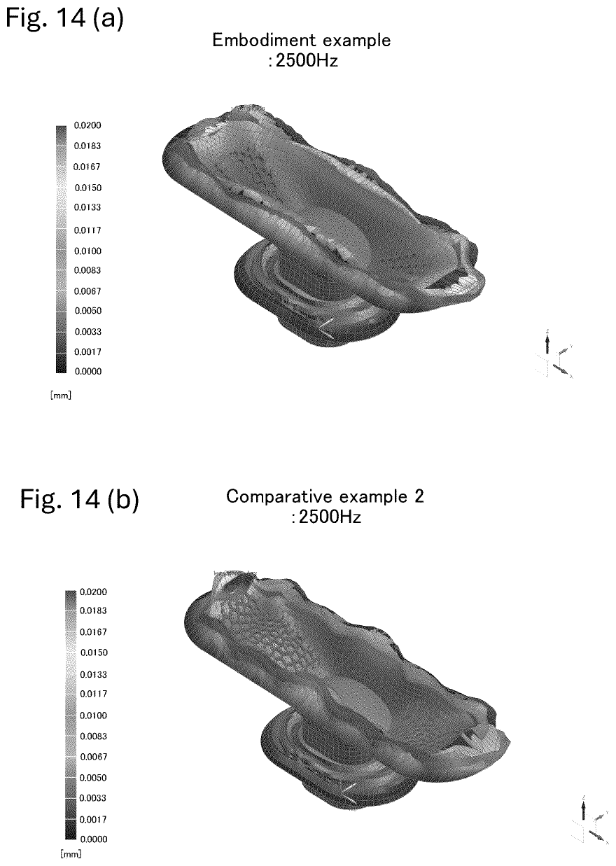

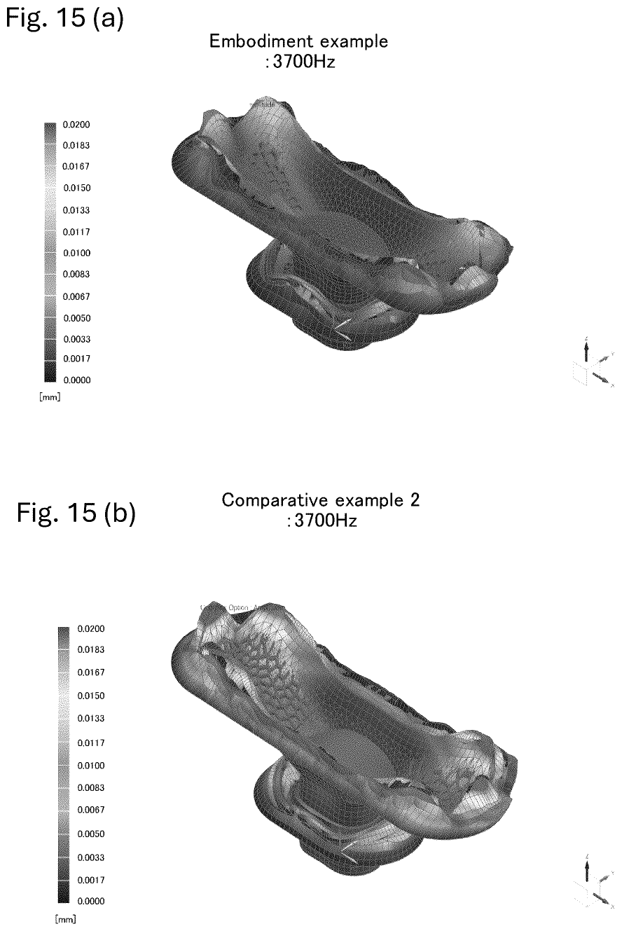

FIG. 13 is a graph illustrating frequency characteristics of the embodiment example, the comparative example 2 and the comparative example 3. FIG. 14(a) is a diagram illustrating movement of a model of the embodiment example in 2500 Hz. FIG. 14(b) is a diagram illustrating movement of a model of the comparative example 2 in 2500 Hz. Like an aspect ratio is approximately 4:1, in a thin and long shape in which an aspect ratio is large, the extent of increasing rigidity in a longitudinal direction by only a recessed-raised wing veins pattern rib like the comparative example 2 is limited, flapping of an edge is seen and large dips occur. Similarly, also in the comparative example 2, since a wing veins pattern rib is arranged on a raised rib, effectiveness of the raised rib is degraded. Meanwhile, in the embodiment example, such phenomena are not seen. FIG. 15(a) is a diagram illustrating movement of a model of the embodiment example in 3700 Hz. FIG. 15(b) is a diagram illustrating movement of a model of the comparative example 2 in 3700 Hz. In the comparative example 2, rutting of an edge is large by flapping of the diaphragm and resonance peak occurs. Meanwhile, in the embodiment example, such phenomena are not seen.

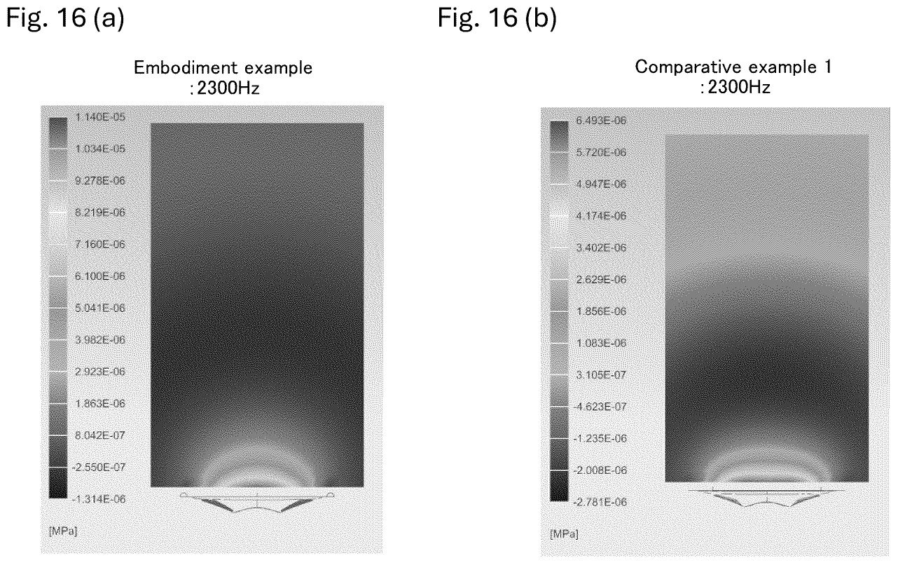

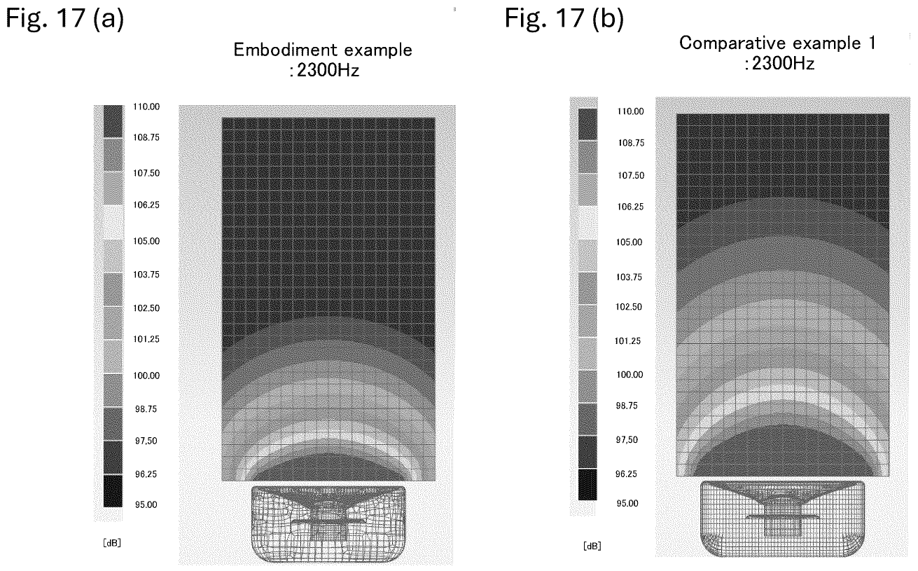

FIG. 16(a) is a diagram illustrating a wavefront of a longitudinal direction of the embodiment example in 2300 Hz. FIG. 16(b) is a diagram illustrating a wavefront of a longitudinal direction of the comparative example 1 in 2300 Hz. FIG. 17(a) is a diagram illustrating a sound distribution of a longitudinal direction of the embodiment example in 2300 Hz. FIG. 17(b) is a diagram illustrating a sound distribution of a longitudinal direction of the comparative example 1 in 2300 Hz. In the comparative example 1, although the rutting of an edge is seen, there is not disturbance of the wavefront.

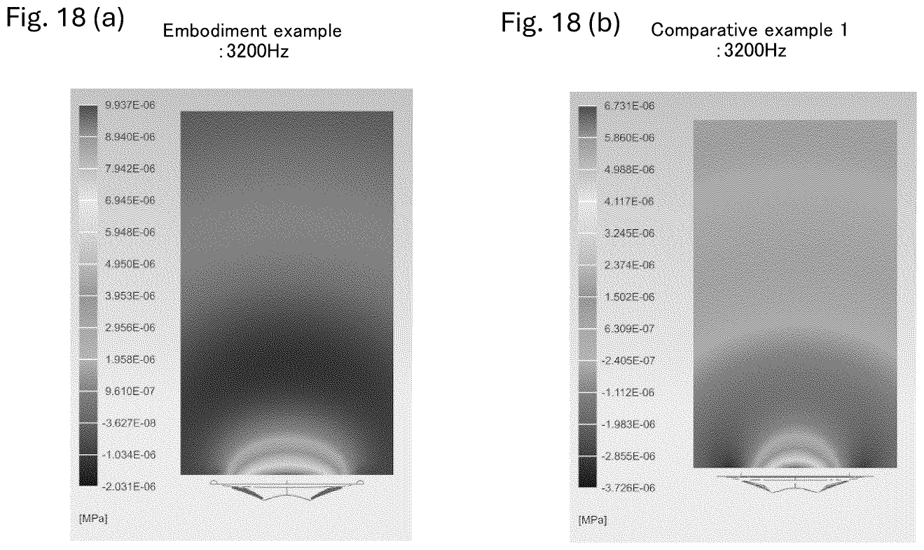

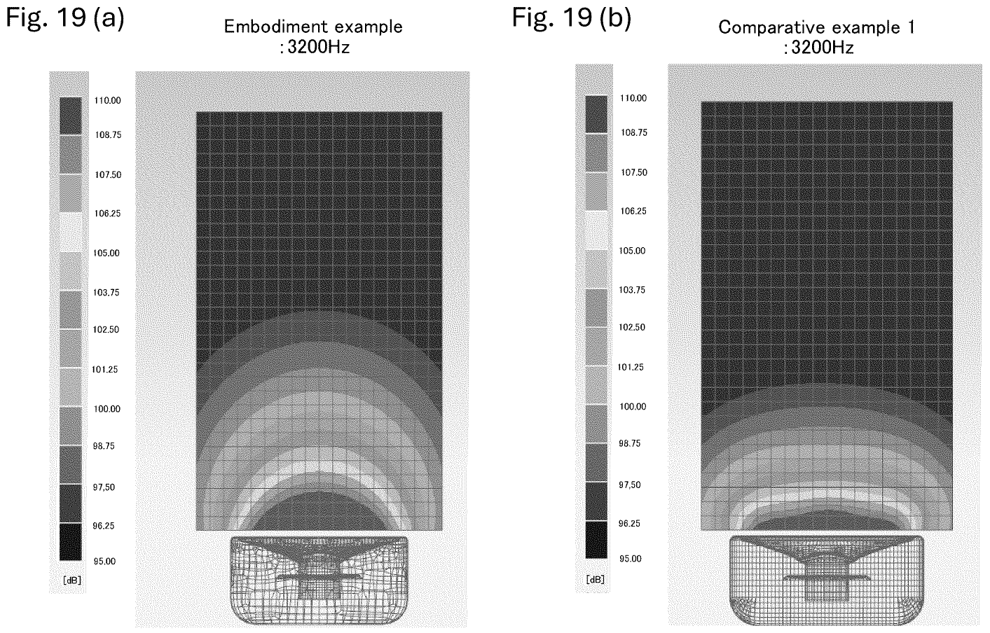

FIG. 18(a) is a diagram illustrating a wavefront of a longitudinal direction of the embodiment example in 3200 Hz. FIG. 18(b) is a diagram illustrating a wavefront of a longitudinal direction of the comparative example 1 in 3200 Hz. FIG. 19(a) is a diagram illustrating a sound distribution of a longitudinal direction of the embodiment example in 3200 Hz. FIG. 19(b) is a diagram illustrating a sound distribution of a longitudinal direction of the comparative example 1 in 3200 Hz. In the comparative example 1, disturbance of the wavefront occurs by an opposite phase mode of a longitudinal direction. Meanwhile, disturbance of the wavefront is not seen in the embodiment example.

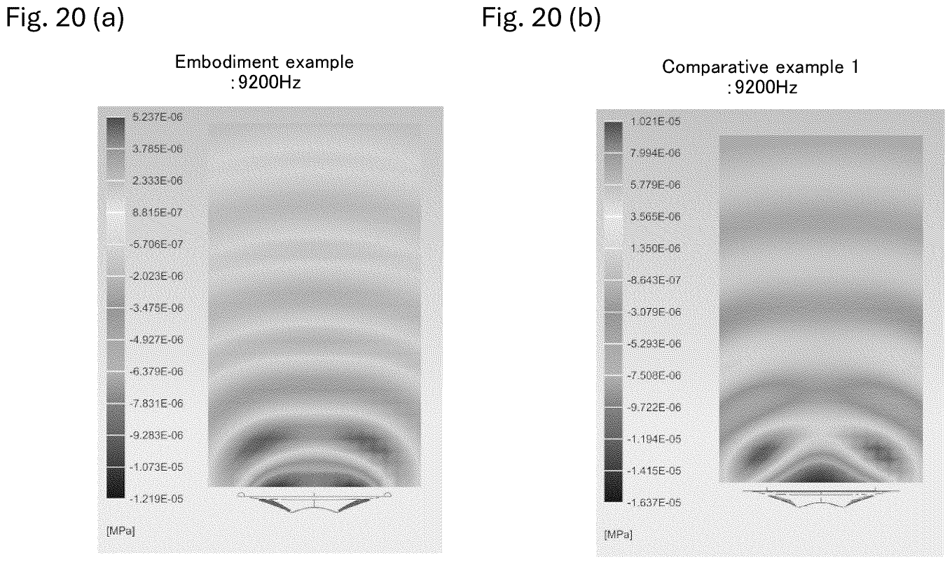

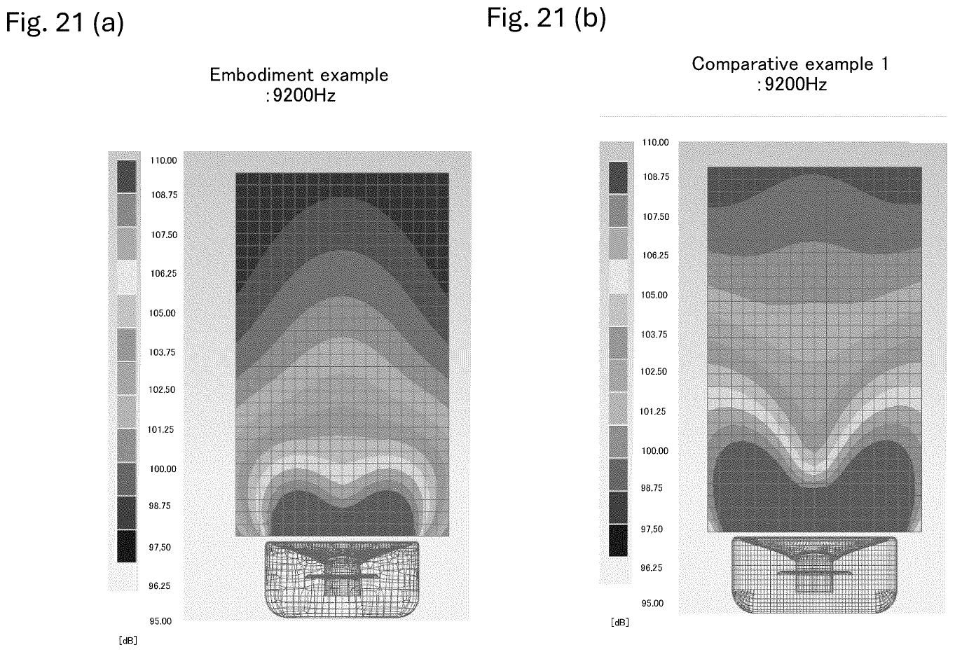

FIG. 20(a) is a diagram illustrating a wavefront of a longitudinal direction of the embodiment example in 9200 Hz. FIG. 20(b) is a diagram illustrating a wavefront of a longitudinal direction of the comparative example 1 in 9200 Hz. FIG. 21(a) is a diagram illustrating a sound distribution of a longitudinal direction of the embodiment example in 9200 Hz. FIG. 21(b) is a diagram illustrating a sound distribution of a longitudinal direction of the comparative example 1 in 9200 Hz. In the comparative example 1, since divided resonance in the longitudinal direction occurs, the wavefront is largely disturbed. Meanwhile, in the embodiment example, there is no large disturbance and the wavefront which is close to a spherical surface is maintained.

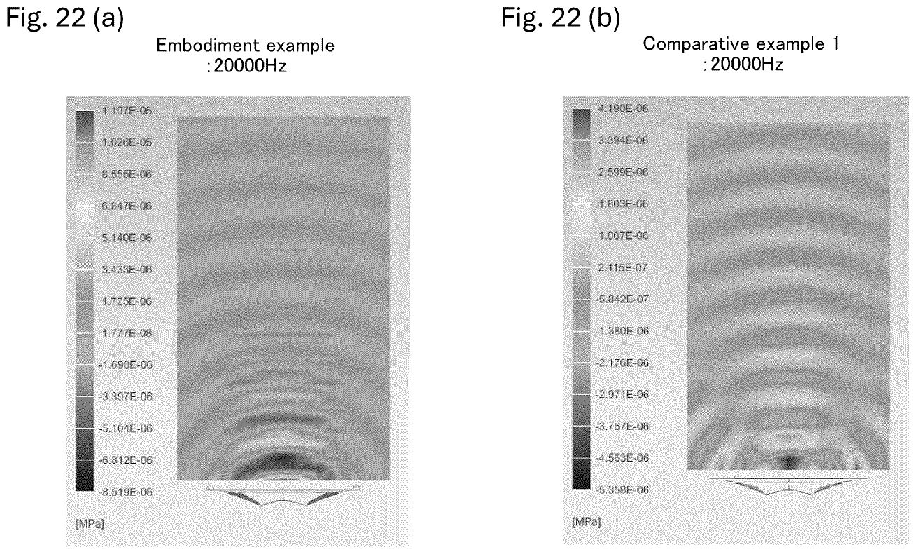

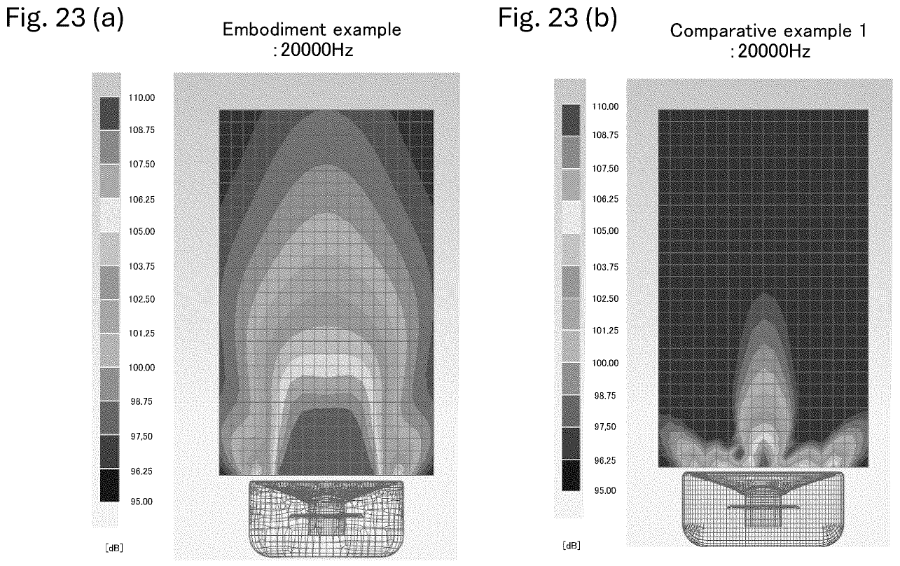

FIG. 22(a) is a diagram illustrating a wavefront of a longitudinal direction of the embodiment example in 20000 Hz. FIG. 22(b) is a diagram illustrating a wavefront of a longitudinal direction of the comparative example 1 in 20000 Hz. FIG. 23(a) is a diagram illustrating a sound distribution of a longitudinal direction of the embodiment example in 20000 Hz. FIG. 23(b) is a diagram illustrating a sound distribution of a longitudinal direction of the comparative example 1 in 20000 Hz. In the comparative example 1, the wavefront is largely disturbed by divided resonance. Meanwhile, in the embodiment example, since the first reinforcing part 3 and the second reinforcing part 4 are simultaneously used, the wavefront which is close to a spherical surface is maintained.

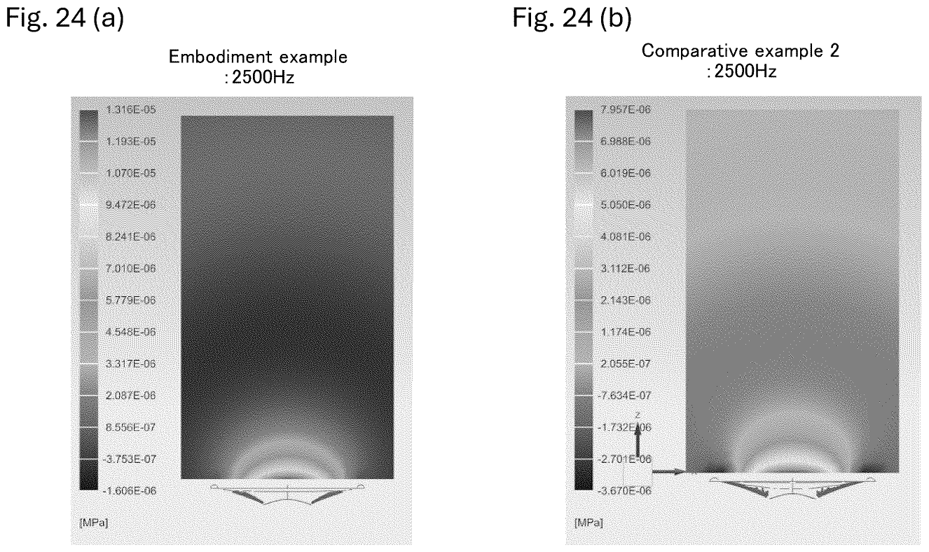

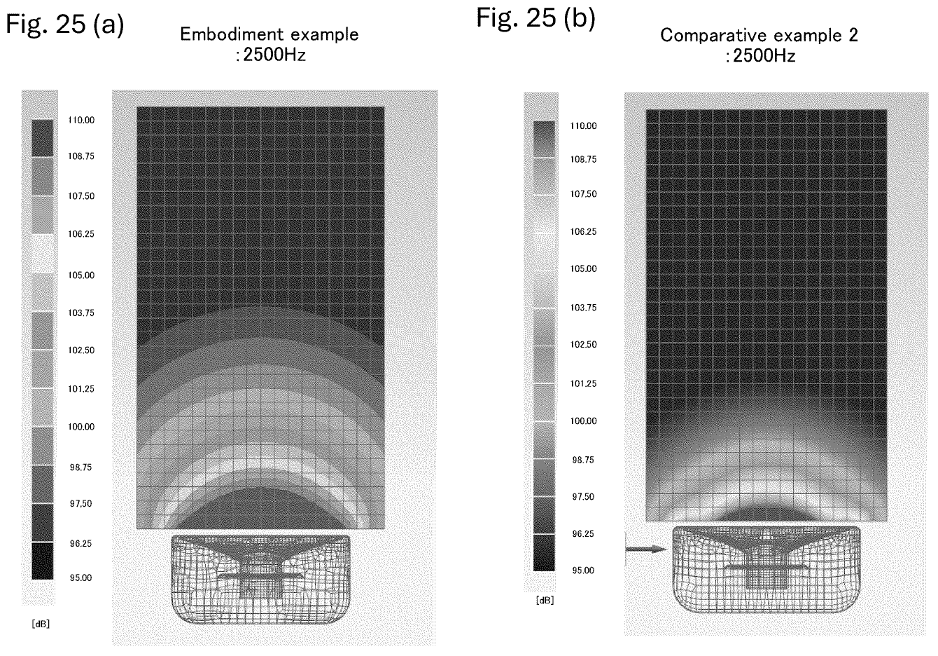

FIG. 24(a) is a diagram illustrating a wavefront of a longitudinal direction of the embodiment example in 2500 Hz. FIG. 24(b) is a diagram illustrating a wavefront of a longitudinal direction of the comparative example 2 in 25000 Hz. FIG. 25(a) is a diagram illustrating a sound distribution of a longitudinal direction of the embodiment example in 2500 Hz. FIG. 25(b) is a diagram illustrating a sound distribution of a longitudinal direction of the comparative example 2 in 2500 Hz. In the comparative example 2, disturbance of the wavefront occurs by the rigidity shortage in the longitudinal direction. In the embodiment example, there is no large disturbance and a spherical surface wave is maintained.

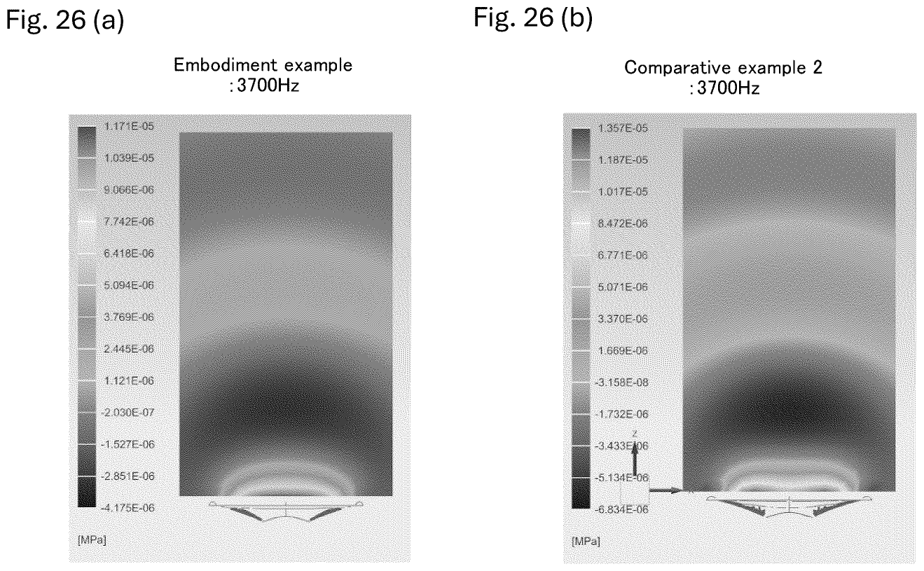

FIG. 26(a) is a diagram illustrating a wavefront of a longitudinal direction of the embodiment example in 3700 Hz. FIG. 24(b) is a diagram illustrating a wavefront of a longitudinal direction of the comparative example 2 in 37000 Hz. FIG. 27(a) is a diagram illustrating a sound distribution of a longitudinal direction of the embodiment example in 3700 Hz. FIG. 27(b) is a diagram illustrating a sound distribution of a longitudinal direction of the comparative example 2 in 3700 Hz. In the comparative example 2, the wavefront is slightly disturbed due to flapping of an edge in the longitudinal direction. Meanwhile, in the embodiment example, there is no large disturbance of the wavefront.

As described above, in the embodiment, the first reinforcing part 3 which extends along the longitudinal direction and the second reinforcing part 4 which is adjacent to the first reinforcing part 3 and has a mesh shape raised-recessed portion are provided. For this reason, (1) flapping of the edge 5 which is provided in the diaphragm 1 is suppressed. Further, (2) the entire rigidity increases by the first reinforcing part 3 and resonance peak is effectively dispersed by the second reinforcing part 4. According to the embodiment, peak dips in the diaphragm 1 are suppressed by (1) or (2).

Further, the second reinforcing part 4 has a skeleton which spreads radially from the center along the longitudinal direction and plays a role to complement the first reinforcing part 3. For this reason, the divided resonance in high frequency is decreased.

Herein, it is preferable that an aspect ratio of the length in the longitudinal direction and the length in the short direction in the diaphragm 1 is not less than 2:1. More preferably, it is not less than 3:1. This is because in a diaphragm with a large aspect ratio, the longitudinal stiffness is insufficient, but the effect by the first reinforcing part 3 and the second reinforcing part 4 is more effective in such a diaphragm.

Further, for example, the mesh by the raised-recessed portion of the second reinforcing part 4 may be lattice (state in which a plurality of vertical lines and a plurality of horizontal lines cross). The mesh by the raised-recessed portion of the second reinforcing part 4 may, for example, be a regular shape with a plurality of raised portions by rectangles of the same shape. If the mesh by the raised-recessed portion of the second reinforcing part 4 is a shape which does not have regularity like the wing veins pattern described in the embodiment, effect of resonance dispersion by the second reinforcing part 4 is large.

The embodiment of the present disclosure is described above, but the mode to which the present disclosure is applicable is not limited to the above embodiment and can be suitably varied without departing from the scope of the present disclosure.

The present disclosure can be suitably employed in a diaphragm and a speaker unit including the diaphragm.

What is claimed is:

1. A diaphragm in which one axis direction length and the other axis direction length are different in two orthogonal axis directions seen from a top and which has a predetermined shape that both sides in a longitudinal direction which is the one axis direction are constituted of curved lines, the diaphragm comprising:
a first reinforcing part which extends along the longitudinal direction; and
a second reinforcing part which is provided adjacent to the first reinforcing part in a short direction and which is a mesh shape raised-recessed portion.

2. The diaphragm according to claim 1,
wherein the second reinforcing part imitates a wing of an insect.

3. The diaphragm according to claim 2,
wherein the second reinforcing part is based on data obtained by measurement of an actual shape of a wing vein of the insect or data of a Voronoi diagram imitating the wing vein of the insect.

4. The diaphragm according to claim 1,
wherein the second reinforcing part has
a plurality of polygonal shape raised portions, and
a plurality of polygonal shape recessed portions which are formed in insides of the raised portions by the raised portions, and
in the plurality of raised portions, one side of the adjacent raised portion is a part which forms both polygons.

5. The diaphragm according to claim 1,
wherein the second reinforcing part radially spreads from a center along the longitudinal direction.

6. The diaphragm according to claim 1,
wherein two of the second reinforcing parts are provided across the first reinforcing part in the short direction.

7. The diaphragm according to claim 6,
wherein in the two second reinforcing parts, shapes of mesh are different from each other.

8. The diaphragm according to claim 6,
wherein two sets of the first reinforcing part and the two second reinforcing parts are provided across a center of the longitudinal direction.

9. The diaphragm according to claim 8,
wherein the two second reinforcing parts across the center of the longitudinal direction are point symmetrical against the center.

10. The diaphragm according to claim 1,
wherein a width of the first reinforcing part gradually gets thinner from a center of the longitudinal direction along the longitudinal direction.

11. The diaphragm according to claim 1,
wherein an aspect ratio of a length of the longitudinal direction and a length of the short direction is not less than 2:1.

12. A speaker unit comprising:
a diaphragm;
a voice coil which is connected to an opening of the diaphragm;
a dust cap which is coupled to the voice coil;
an edge which is coupled to an outer circumference of the diaphragm;
a frame to which an outer circumference of the edge is fixed; and
a magnetic circuit which has a magnetic gap in which a coil of the voice coil is disposed and is fixed to frame,
wherein the diaphragm has one axis direction length and the other axis direction length different in two orthogonal axis directions seen from a top and has a predetermined shape that both sides in a longitudinal direction which is one axis direction are constituted of curved lines, the diaphragm including
a first reinforcing part which extends along the longitudinal direction; and
a second reinforcing part which is provided adjacent to the first reinforcing part in a short direction and which has a mesh shape raised-recessed portion.
